(19) United States
(12) Patent Application Publication
(10) Pub. No.: US 2013/0054694 A1
(43) Pub. Date: Feb. 28, 2013

(54) TERMINAL, SERVER, AND METHOD FOR TRANSMITTING AND RECEIVING PRESENCE INFORMATION

(71) Applicants: Jae Hyun MAENG, Seoul (KR); Young Jin JUNG, Seoul (KR); Ui Chang JUNG, Seoul (KR)

(72) Inventors: Jae Hyun MAENG, Seoul (KR); Young Jin JUNG, Seoul (KR); Ui Chang JUNG, Seoul (KR)

(73) Assignee: PANTECH CO., LTD., Seoul (KR)

(21) Appl. No.: 13/312,914

(22) Filed: Dec. 6, 2011

(30) Foreign Application Priority Data
Aug. 24, 2011 (KR) 10-2011-0084516

(51) Int. Cl. G06F 15/16

(52) U.S. Cl. 709/204

(57) ABSTRACT

An IMS includes a terminal and an Internet Protocol Multimedia Subsystem (IMS) server, and may perform a method for transmitting and receiving presence information via the IMS core unit, a registering unit, a presence information transmitting unit, a friend list unit and a presence information control unit. The IMS core unit processes an IMS protocol. The registering unit registers terminal information to the IMS server. The presence information transmitting unit transmits presence information to the IMS server. The friend list unit manages a friend list of the various terminals. The presence information control unit designates at least one friend in the friend list and requests presence information of the designated friend.

### CROSS-REFERENCE TO RELATED APPLICATION

This application claims priority from and the benefit under 35 U.S.C. §119(a) of Korean Patent Application No. 10-2011-0084516, filed on Aug. 24, 2011, which is incorporated by reference for all purposes as if fully set forth herein.

### BACKGROUND

1. Field

The present disclosure relates to a terminal, an IP Multimedia Subsystem (IMS) server, and a method for transmitting and receiving presence information.

2. Discussion of the Background

Wireless communication, along with wired communication, has been integrated to an Internet Protocol (IP) based network. An example of a platform of an All-IP based next-generation communication service is an IP Multimedia Subsystem (IMS), which integrates wired and wireless networks and allows broadcast communication fusion convergence.

An IMS proposed in 3rd Generation Partnership Project (3GPP) is an All-IP based next-generation communication service platform, which integrates wired and wireless networks and allows various kinds of broadcast communication services to be provided. In the IMS network, the converged service is provided to a user, with it being possible to provide a service customized for the user by using the service profile of the user.

In order to provide a user with various kinds of IMS-based services, the presence of the user is managed, thus allowing for retrieving of information for each service, and to check related information in real-time in response to changed information of a corresponding user. In order to accomplish the above, a presence information management based on Extended Markup Language (XML) Configuration Access Protocol (XCAP) and event processing using Session Initiation Protocol (SIP) has been proposed for the IMS.

The presence information notifies a current state of another user registered by the user and generally includes state information, such as ‘on-line’, ‘off-line’, ‘absent’, and ‘in a meeting’ and on-line ID information which may be observed in a messenger program.

As disclosed by Korean unexamined patent publication No. 2009-0001719, in a case where the presence information of any one of the other users from among a list of other users registered by a user, a presence server transmits the presence information of the entire list to a terminal.

For example, in a case where 5,000 friends are registered in a fried list of the corresponding terminal, if the presence information of any one of 5,000 friends changes, the presence information of all friends registered in the friend list is transmitted to the terminal. Therefore, as more friends are registered in the friend list, more presence-related data is transmitted.

In addition, since the terminal may have a screen with a limited size, an IMS-based application displaying the presence information may not be contained to the screen size. Further, presence information of other users that is not displayed on the screen and which the user is not interested in may still be received by a background process of the terminal and analyzed and processed, thereby wasting resources.

The presence information changes based on being operated if linked with contact information. Rich Communication Suite (RCS) and Unified Communications (UC) are examples thereof.

Therefore, based on the above examples, the amount of data managed due to the presence information increases.

The above information disclosed in this Background section is only for enhancement of understanding of the background of the invention and therefore it may contain information that does not form any part of the prior art.

### SUMMARY OF THE INVENTION

Exemplary embodiments of the present invention provide a terminal, a server, and a method for transmitting and receiving presence information based on the IMS.

Additional features of the invention will be set forth in the description which follows, and in part will be apparent from the description, or may be learned by practice of the invention.

An exemplary embodiment of the present invention discloses a terminal, including a friend list unit to update a friend list of the terminal; a presence information control unit to manage presence information, the presence information being information of another terminal associated with the friend list; and a presence information transmitting unit to transmit a request for updated presence information of a partial portion of the friend list from a server, wherein the friend list unit receives the updated presence information corresponding to the request and updates the presence information.

An exemplary embodiment of the present invention discloses a method for updating a friend list based on presence information, including: managing the friend list based on the presence information; designating friends of the friend list for updated presence information; requesting the updated presence information from a server based on the designation; receiving the updated presence information from the server; and updating the friend list based on the received updated presence information.

An exemplary embodiment of the present invention discloses an Internet Protocol Multimedia Subsystem (IMS) server, including: a friend list unit to manage a first terminal and a second terminal, the first terminal and the second terminal each having a friend list; a presence information control unit to manage presence information for the first terminal and the second terminal, and to store updated presence information for the first terminal; and a presence information transmitting unit to transmit the updated presence information for the first terminal, wherein in response to a request from the second terminal, the presence information transmitting unit transmits the updated presence information for the first terminal to the second terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic diagram of an IMS according to an exemplary embodiment of the present invention.

FIG. 2 is a block diagram of a terminal according to an exemplary embodiment of the present invention.

FIG. 3 is a block diagram of a presence information determining unit according to an exemplary embodiment of the present invention.

FIG. 4 is a menu of the presence information determining unit according to an exemplary embodiment of the present invention.

FIG. 5 shows a menu of a terminal according to an exemplary embodiment of the present invention.

FIG. 6 shows a menu of a terminal according to an exemplary embodiment of the present invention.

FIG. 7 shows a menu of a terminal according to an exemplary embodiment of the present invention.

FIG. 8 shows a menu of a terminal according to an exemplary embodiment of the present invention.

FIG. 9 shows a menu of a terminal according to an exemplary embodiment of the present invention.

FIG. 10 is a detailed block diagram of a presence information requesting unit according to an exemplary embodiment of the present invention.

FIG. 11, FIG. 12 and FIG. 13 show exemplary commands for generating and requesting presence information according to an exemplary embodiment of the present invention.

FIG. 14 is a flowchart illustrating a method for receiving presence information according to an exemplary embodiment of the present invention.

FIG. 15 is a block diagram of an IMS server according to an exemplary embodiment.

FIG. 16 is a flowchart illustrating a method for transmitting presence information according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

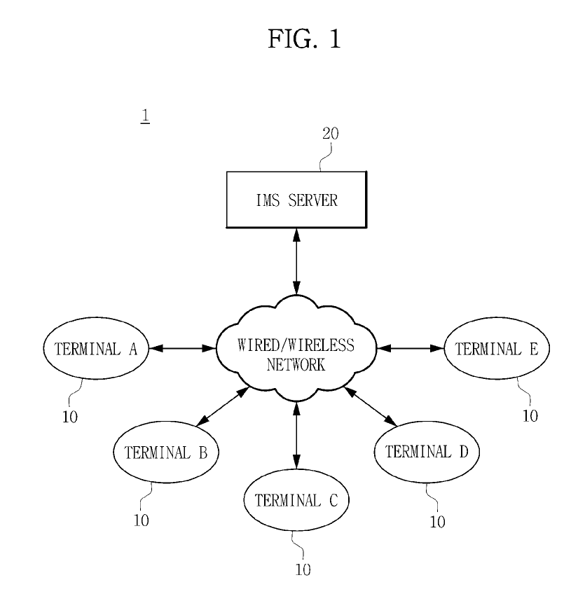

FIG. 1 is a schematic diagram of an IMS according to an exemplary embodiment of the present invention.

Referring to FIG. 1, the IMS 1 includes terminals 10 (as shown by terminals a-e) and an IMS server 20.

The IMS may be a core service control network for the Long Term Evolution (LTE) and WIMAX 4G standard, and domestic/foreign IMS-based services include Instant Messaging (IM), Video Conference Call, Video Share, Unified Communication (UC), Fixed Mobile Convergence (FMC) or the like. The UC is a service for integrating various communication devices, such as a telephone, a fax, an email, a cellular phone, a messenger, a video conference system or the like into a single platform. The FMC is a service capable of using a mobile terminal and WiFi through wired and wireless network, by using one cellular phone so that it may be used on a mobile phone network outside of a WiFi region, and used as an Internet phone in a WiFi region.

The terminal 10 may be any various kinds of wired and wireless communication devices that may connect to the Internet, such as smart phones, tablet PC, PDA, Netbook, and desktops. In this disclosure, terminal 10 may indicate a single terminal, each terminal among multiple terminals, or multiple terminals. The IMS server 20 may be a server that manages presence information or a server that manages overall IMS-based service.

The terminals 10 and the IMS server 20 are connected through a wired and wireless network to transmit and receive presence information. The presence information notifies a current state of another user (hereinafter, referred to as a friend) registered by the user, and includes state information such as ‘on-line’, ‘off-line’, ‘absent’, and ‘in a meeting’ and on-line ID information of a friend corresponding to the presence information.

For example, in an conventional IMS, if there is terminal A and where terminal B and terminal C register terminal A as a friend, if the presence information of terminal A changes, the presence information of terminal A is transmitted to terminal B and terminal C through the IMS server 20 without checking whether terminal B and terminal C have requested presence information of terminal A.

On the other hand, according to the exemplary embodiment, if terminal B and terminal C register terminal A as a friend, and if terminal B requests the presence information of terminal A and terminal C does not request the presence information of terminal A, the presence information of terminal A is transmitted to terminal B, and is not transmitted to terminal C.

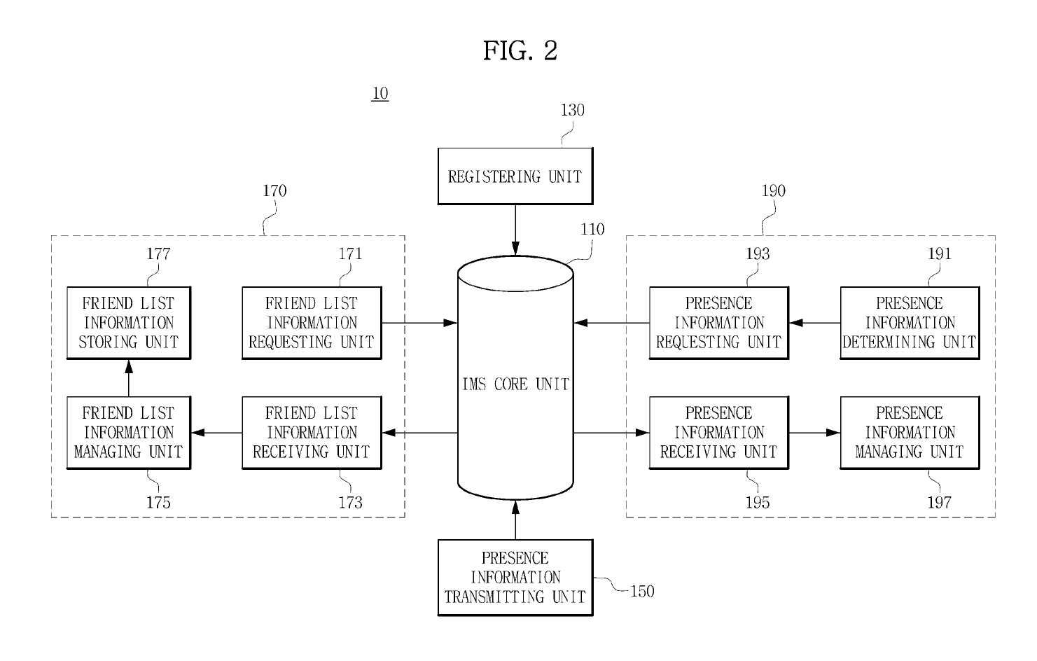

FIG. 2 is a block diagram of a terminal according to an exemplary embodiment of the present invention.

Referring to FIG. 2, the terminal 10 includes an IMS core unit 110, a registering unit 130, a presence information transmitting unit 150, a friend list unit 170, and a presence information control unit 190.

The IMS core unit 110 is an IMS protocol engine that supports communication between terminal 10 and the IMS server 20, and terminal 10 transmits and receives friend list information, presence information or the like through the IMS core unit 110.

The registering unit 130 registers terminal 10 to the IMS server 20 in response to power being applied to terminal 10, or if terminal 10 awakes or leaves a standby state, or where terminal 10 connects to an IMS-based service. The registering unit 130 transmits the information of terminal 10 to the IMS server 20 through a Session Initiation Protocol (SIP) REGISTER command. The information may pertain to user ID, phone number, mail address and capacity.

The SIP is an IP-based cession control protocol regulated in standard Request for Comments of the Internet Engineering Task Force (RFC2163 of IETF). The SIP controls the cession control of services such as VoIP, messaging, multimedia control, and IPTV, and a standard protocol which serves as a basis of the IMS.

The presence information transmitting unit 150 transmits the presence information of terminal 10 to the IMS server 20 if terminal 10 is registered with the IMS server 20. The presence information transmitting unit 150 transmits the presence information of terminal 10 to the IMS server 20 through an SIP PUBLISH command.

Thus, if the presence information of the terminal 10 changes, the presence information transmitting unit 150 transmits the changed presence information to the IMS server 20.

The friend list unit 170 manages a friend list where friends of terminal 10 are registered. The friend list unit 170 includes a friend list information requesting unit 171, a friend list information receiving unit 173, a friend list information managing unit 175 and a friend list information storing unit 177.

The friend list information requesting unit 171 requests the friend list information of terminal 10 from the IMS server 20. The friend list information requesting unit 171 may request the friend list information from the IMS server 20 through an XML Configuration Access Protocol (XCAP) GET command.

The XCAP is a HTTP-based XML document access standard defined by a working group of SIP for Instant Messaging and Presence Leveraging Extensions (SIMPLE) of IETF. The XCAP uses GET, PUT, and DELETE, which are HTTP various techniques and commands, for inquiring, changing or deleting specific information of an XML document.

Since the XCAP is an addressing-related standard based on an HTTP protocol, HTTP request and response syntax may be used. The XCAP may generate, change, inquire or delete an XML document. The HTTP PUT command is used for generation and changing, GET is used for inquiring, and DELETE is used for deletion.

The friend list information receiving unit 173 receives the friend list information of terminal 10 from the IMS server 20. The friend list information managing unit 175 analyzes the received friend list information and extracts and manages the information.

The friend list information storing unit 177 stores the received friend list information.

The presence information control unit 190 includes a presence information determining unit 191, a presence information requesting unit 193, a presence information receiving unit 195, and a presence information managing unit 197.

The presence information determining unit 191 determines friends of whom terminal 10 will receive presence information, and designates at least one friend in the friend list.

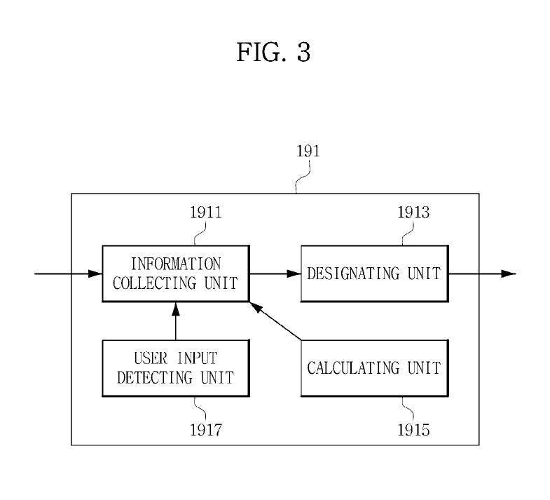

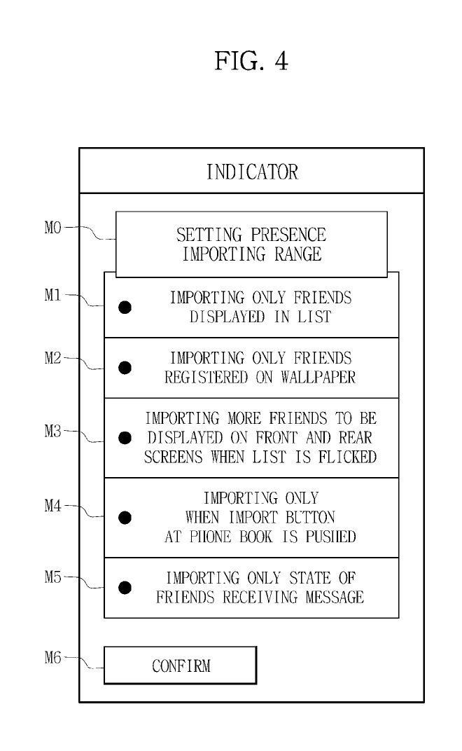

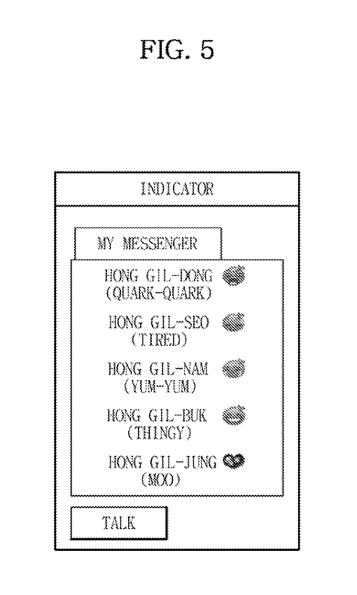

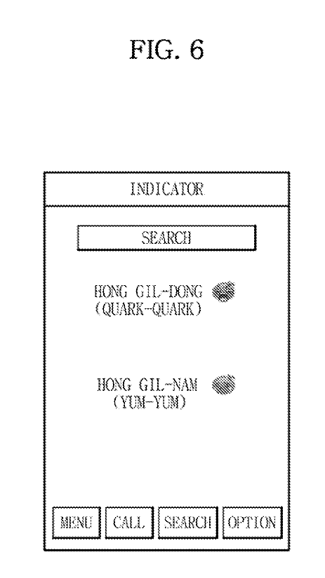

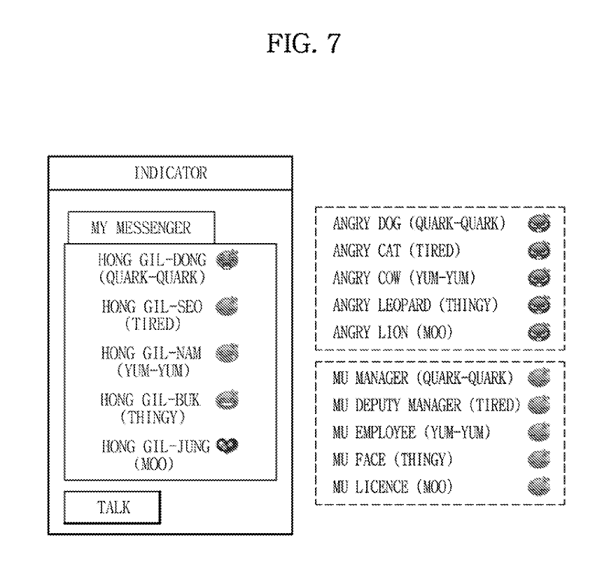

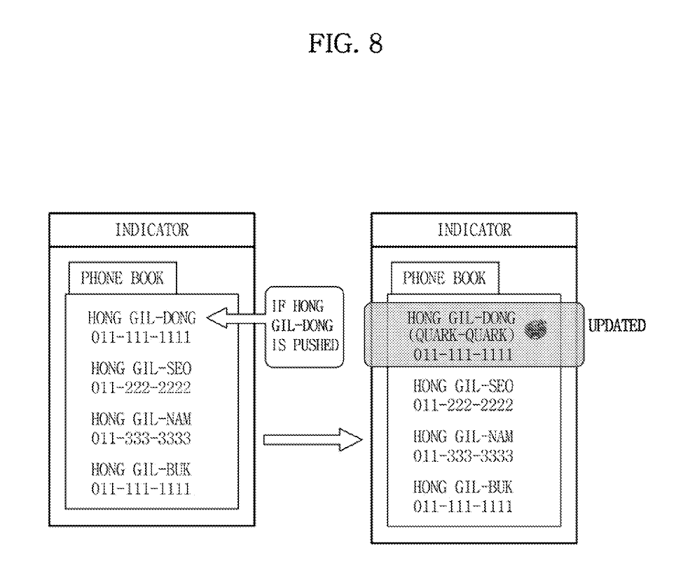

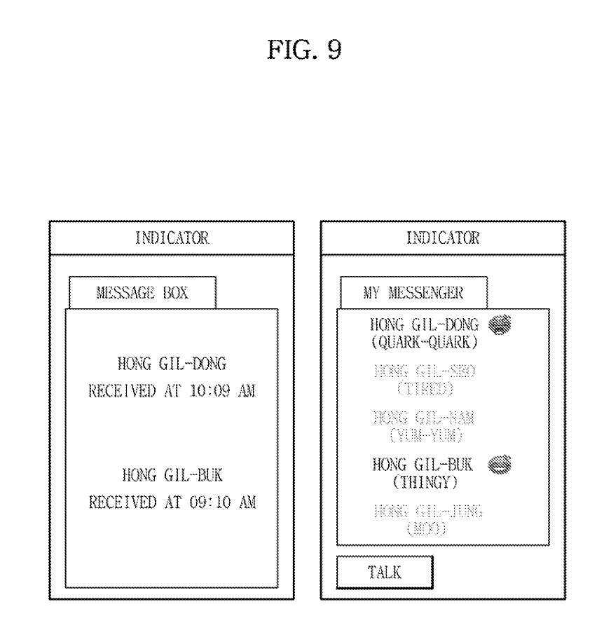

FIG. 3 is a block diagram of a presence information determining unit according to an exemplary embodiment of the present invention. FIG. 4 is a menu of the presence information determining unit according to an exemplary embodiment of the present invention. FIG. 5 shows a menu of a terminal according to an exemplary embodiment of the present invention. FIG. 6 shows a menu of a terminal according to an exemplary embodiment of the present invention. FIG. 7 shows a menu of a terminal according to an exemplary embodiment of the present invention. FIG. 8 shows a menu of a terminal according to an exemplary embodiment of the present invention. FIG. 9 shows a menu of a terminal according to an exemplary embodiment of the present invention.

Referring to FIG. 3, the presence information determining unit 191 may include an information collecting unit 1911 that collects information from terminal 10, a designating unit 1913 that designates a friend whose presence information is requested from the collected information, a calculating unit 1915 that calculates the number of friends whose presence information is requested, and a user input detecting unit 1917 that detects an input from a user.

The terminal 10 may have a setting menu for setting friends whose presence information will be received. As shown in FIG. 4, each item of presence importing range setting (M0) may be configured with setting menu items, such as importing friends displayed in the friend list (M1), importing friends registered on a wallpaper (M2), importing more friends to be displayed on front and rear screens if the friend list is scrolled (M3), importing friends if an import button of a phone book is pushed (M4), and importing states of friends who receive a message (M5).

If the user selects the presence importing range setting (M0), the setting friends whose presence information will be imported is initiated, and if all the items (M1 to M5) and the confirmation (M6) are selected, the setting friends whose presence information will be imported is terminated.

In the following examples depicted in FIG. 5, FIG. 6, FIG. 7, FIG. 8 and FIG. 9, the various options and screens may be selected through the menu provide in FIG. 4. However, aspects of this disclosure are not limited therein.

FIG. 5 shows an example of importing friends displayed on the friend list if (M1) is selected. In this case, the calculating unit 1915 may calculate the number of friends displayable by terminal 10 and provide the number to the information collecting unit 1911.

FIG. 6 shows an example of importing friends registered on a wallpaper if (M2) is selected. In this case, the information collecting unit 1911 collects information of friends registered on the wallpaper, and the designating unit 1913 designates only friends registered on the wallpaper. Friends registered on a wallpaper may refer to friends who are shown during a certain state of operation for terminal 10, such as during a standby or idle state.

FIG. 7 shows an example of importing more friends to be displayed on front and rear screens if the friend list is scrolled if (M3) is selected. In this case, the user input detecting unit 1917 detects an input of the user and provides the information to the calculating unit 1915. The calculating unit 1915 may calculate scrolling of the friend list according to the input of the user detected by the user input detecting unit 1917, calculate the number of friends displayable on the front and rear screens of the friend list currently displayed on the screen of terminal 10, and provide the same to the information collecting unit 1911. In this disclosure, front and rear screens of terminal 10 may refer to screens that are currently being viewed, previously been viewed, or the next screen to be viewed.

FIG. 8 shows an example of importing friends if an import button of a phone book is pushed if (M4) is selected. In this case, the information collecting unit 1911 collects information of the selected friends, and the designating unit 1913 designates the friends that have been selected by the user.

FIG. 9 shows an example of importing states of friends who receive a message if (M5) is selected. In this case, the information collecting unit 1911 collects information of the friends that receive a message, and the designating unit 1913 designates the friends that have received a message. The designating unit 1913 may arrange the friends that receive a message in various ways, such as sorting the friends by those that have received the most recent message or those that receive the greatest number of messages over a reference time such as the day, the week, or more, including since each friend has been registered. The designating unit 1913 may designate each friend by assigning each friend a rank N (N is an integer), where N denotes a placement relative to all the friends based on the regime used to sort the friend list.

The presence information requesting unit 193 requests the presence information of the designated friends from the IMS server 20. The presence information requesting unit 193 requests the presence information from the IMS server 20 through the SIP SUBSCRIBE command.

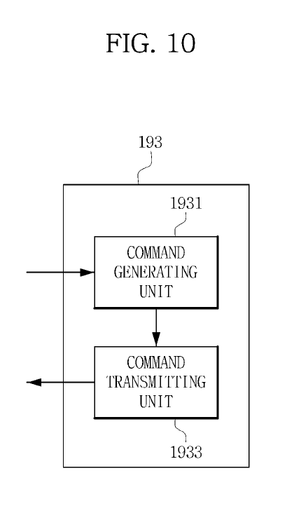

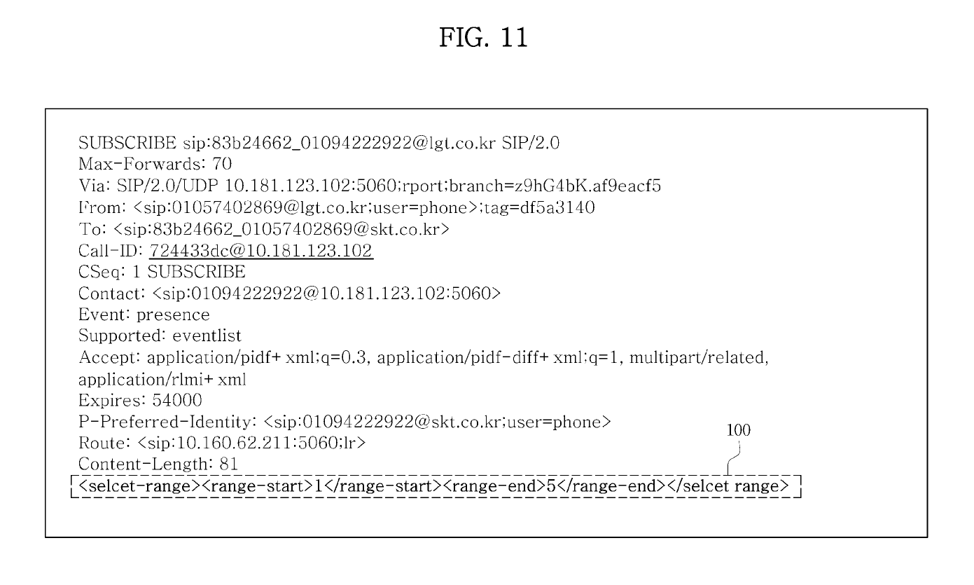

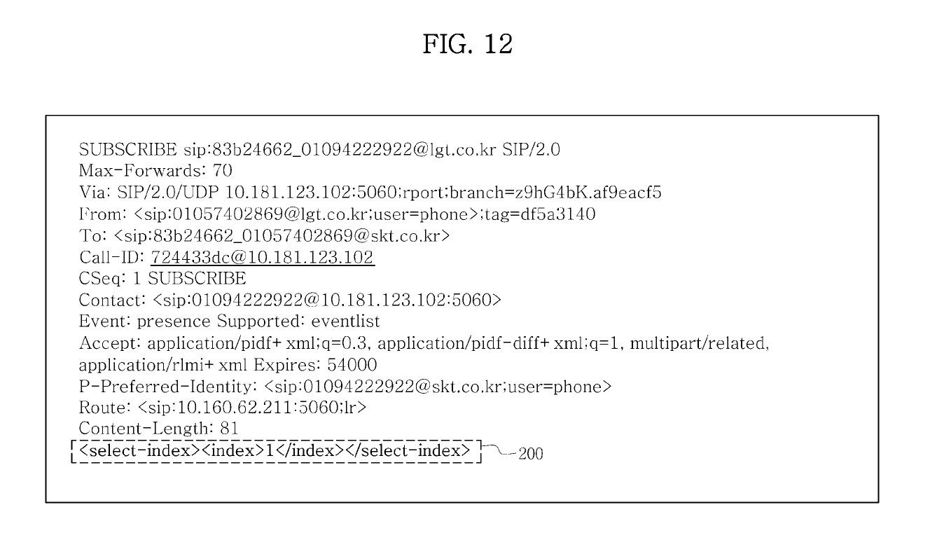

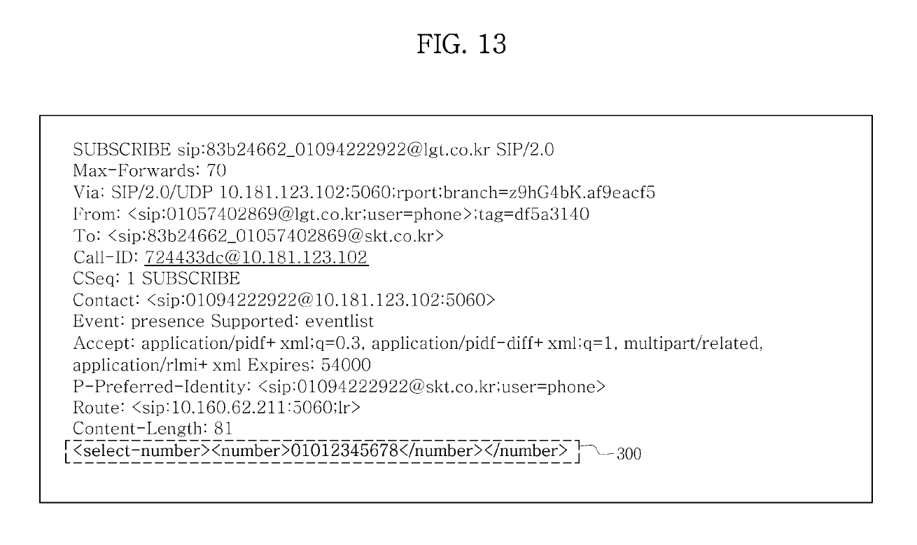

FIG. 10 is a detailed block diagram of a presence information requesting unit according to an exemplary embodiment of the present invention. FIG. 11, FIG. 12 and FIG. 13 show exemplary commands for generating and requesting presence information according to an exemplary embodiment of the present invention.

Referring to FIG. 10, the presence information requesting unit 193 may include a command generating unit 1931 to generate SIP SUBSCRIBE commands, which includes the information of the designated friends, and a command transmitting unit 1933 to transmit the generated SIP SUBSCRIBE command to the IMS server 20.

The presence information requesting unit 193 may request the present information from the IMS server 20 by using various parameters, such as range, index, ID and number information of the friends designated (which as explained above, may be generated by the designating unit 1913).

FIG. 11 shows an example of the SIP SUBSCRIBE command designating a specific range of friends, which includes a tag 100 designating a specific range of friends.

In a case where the presence information determining unit 191 designates a specific range of friends whose presence information will be utilized, the command generating unit 1931 may generate a SIP SUBSCRIBE command that includes a tag 100 designating the specific range of the friends.

For example, if importing friends displayed on the friend list (M1) is executed, the range of the friends designated by the presence information determining unit 191 corresponds to the friends displayed in the friend list, and is added to the SIP SUBSCRIBE command.

Similarly, if importing more friends to be displayed on front and rear screens if the friend list is scrolled (M3) is executed, the range of the friends designated by the presence information determining unit 191, in other words the friends displayable on the front and rear screens of the friend list, is added to the SIP SUBSCRIBE command.

FIG. 12 shows an example of the SIP SUBSCRIBE command designating a specific index of friends, which includes a tag 200 designating a specific index of friends.

If the presence information determining unit 191 designates a specific index of friends whose presence information will be utilized, the command generating unit 1931 may generate a SIP SUBSCRIBE command that includes a tag 200 designating the specific category and index of the friends.

If the friends of the friend list are classified into categories, a category may be designated, and friends corresponding to that category may be set as the range. For example, in a case where a friend category or coworker category is selected, the selected index is added to the SIP SUBSCRIBE command. Specifically, if a category corresponds to where friends have last names starting with K (such as Kim and Kang) or where friends have IDs starting with a, the selected category may be added to the SIP SUBSCRIBE command.

FIG. 13 shows an example of the SIP SUBSCRIBE command designating a specific number of friends, which includes a tag 300 designating a specific number of friends.

If the presence information determining unit 191 designates a specific number of friends whose presence information will be utilized, the command generating unit 1931 may generate a SIP SUBSCRIBE command that includes a tag 300 designating the specific number of the friends.

For example, if importing friends registered on a wallpaper (M2) is executed, the presence information determining unit 191 adds numbers of the designated friends, for example, the friends registered on the wallpaper, to the SIP SUBSCRIBE command.

The presence information receiving unit 195 receives the presence information of the designated friends from the IMS server 20. The presence information receiving unit 195 receives the presence information from the IMS server 20 through the SIP NOTIFY command.

The presence information managing unit 197 analyzes and manages the received presence information.

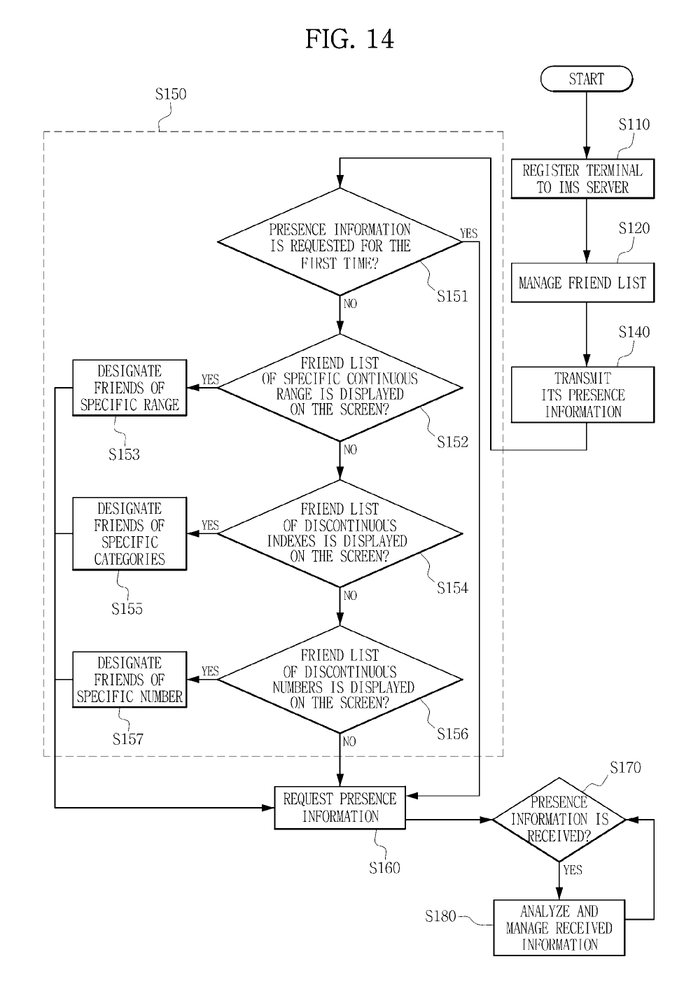

FIG. 14 is a flowchart illustrating a method for receiving presence information according to an exemplary embodiment of the present invention. The method shown in FIG. 14 will be described as if performed by the IMS shown in FIG. 1, but is not limited as such.

Referring to FIG. 14, if power is applied to the terminal 10, or if terminal 10 is turned on or awoken from a standby state, the information of terminal 10 is registered to the IMS server 20 (S110). After which, the friend list of the terminal 10 is managed (S120).

The managing the friend list of the terminal 10 (S120) may include various operations, such as requesting friend list information from the IMS server 20, receiving the friend list information from the IMS server 20, analyzing the received friend list information, and storing the received friend list information.

The terminal 10 transmits its presence information to the IMS server 20 (S140). The managing of the friend list of terminal 10 (S120) and the transmitting of the presence information of terminal 10 (S140) may be executed in any order.

After which, at least one friend (which may include multiple friends) is designated in the friend list (S150) and the presence information of the designated friend (or friends) is requested (S160).

The designating of at least one friend in the friend list (S150) may include collecting information for terminal 10 and designating friends whose presence information will be requested from the collected information.

Specifically, it is determined whether terminal 10 requests presence information for the first time (S151). In a case where the terminal 10 requests presence information for the first time, the presence information of the entire friend list is requested (S160).

If terminal 10 requests presence information for any time other than the first time, a determination may be made whether a friend list in a specific continuous range is to be displayed on terminal 10 (S152). In a case where a friend list in a specific range (such as in continuous or sequentially manner) is displayed on terminal 10, the friends in that specific range are designated (S153).

If the determination of operation 152 is NO, a determination may be made to display a friend list of discontinuous or non-sequential friends (which may be based on categories) on terminal 10 (S154). If a friend list of a discontinuous friend list is displayed on terminal 10, friends in the specific categories are designated (S155).

If the determination of operation S154 is NO, a determination is made whether a friend list to be displayed does not correspond to either a range or category on terminal 10 (S156). In this case designated friends that do not correspond to a specific range or category are displayed on terminal 10, with those friends being designated (S157).

In FIG. 14, and the description above, the determinations of operations S152, S154 and S156 are performed successively. However, each of the above operations may be performed independently, and two or more operations may be performed in combination. Further, in different implementations, various ones of S152, S154 and S156 may be omitted or the other thereof may be changed.

The presence information of the designated friends is requested (S160) based on one or more of the designation of S153, 155, or S157.

After that, if the presence information of the friends designated is received from the IMS server 20 (S170), the received presence information is analyzed and managed (S180). After which, operation S170 may be returned to, to await additional presence information from being received.

According to the presence information receiving method as described above, since present information that is designated from terminal 10 is requested and received by terminal 10, the load and the amount of data communicated may be reduced.

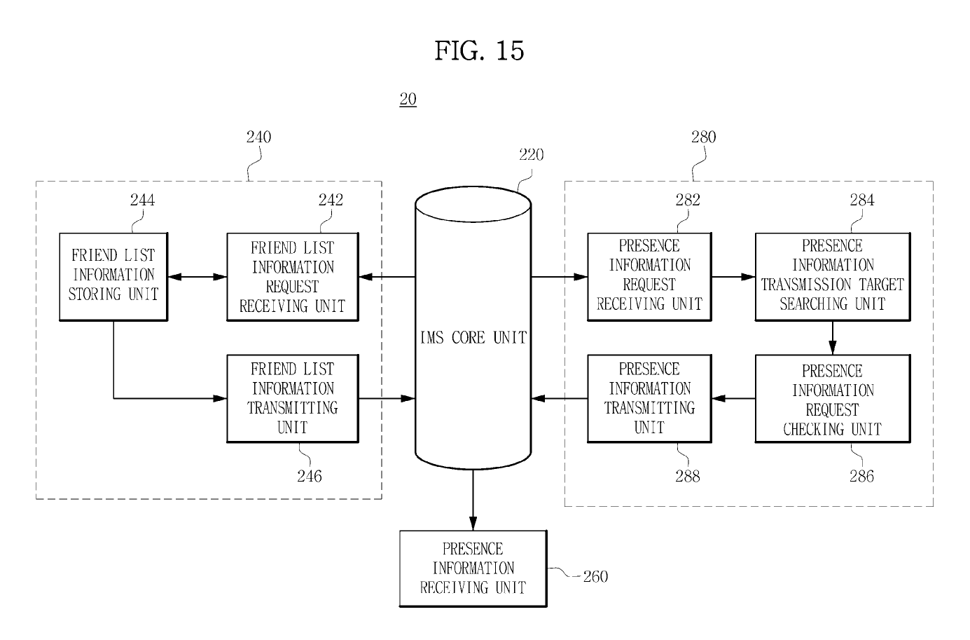

FIG. 15 is a block diagram of an IMS server according to an exemplary embodiment.

Referring to FIG. 15, the IMS server 20 includes an IMS core unit 220, a friend list unit 240, a presence information receiving unit 260 and a presence information control unit 280.

The IMS core unit 220 is an IMS protocol engine that supports the communication between terminal 10 and the IMS server 20, and the IMS server 20 transmits and receives the friend list information, the presence information or the like, through the IMS core unit 220.

The friend list unit 240 manages the friend list of each terminal 10 associated with or registered with the IMS server 20. The friend list unit 240 includes a friend list information request receiving unit 242, a friend list information storing unit 244, and a friend list information transmitting unit 246.

The friend list information storing unit 244 stores the friend list information of each terminal 10. The friend list information request receiving unit 242 receives the request for the friend list information from terminal 10. The request for the friend list information may be received through the XCAP GET command.

In a case where the request for the friend list information is received by the friend list information request receiving unit 242, the friend list information transmitting unit 246 transmits the friend list information stored in the friend list information storing unit 244 to each terminal 10 that has requested specific friend list information. The friend list information may be transmitted through the XCAP PUT command.

The presence information receiving unit 260 receives the presence information of each terminal 10 if registered in the IMS server 20 and if terminal 10's presence information changes. The presence information of the received terminals 10 may be received through the SIP PUBLISH command.

If the presence information of a specific terminal 10 changes, the presence information control unit 280 determines whether each terminal 10 which registers the specific terminal 10 in the friend list requests the presence information of that specific terminal 10, and transmits the presence information of the specific terminal 10 to the each of the terminal 10 that have requested updated presence information.

For example, in a case where terminal B, terminal C, terminal D, and terminal E each register terminal A as a friend, and the presence information of terminal A changes, if terminal B and terminal C request the presence information of terminal A, and terminal D and terminal E do not request the presence information of terminal A, the presence information control unit 280 transmits the presence information of terminal A to terminal B and terminal C and does not transmit the presence information of terminal A to terminal D and terminal E.

The presence information control unit 280 includes a presence information request receiving unit 282, a presence information transmission target searching unit 284, a presence information request checking unit 286, and a presence information transmitting unit 288.

The presence information request receiving unit 282 receives the request for the presence information from terminal 10. The request for the presence information received from terminal 10 may be received through the SIP SUBSCRIBE command.

If the presence information of a specific terminal changes, the presence information transmission target searching unit 284 searches for that terminal, and specifically, if it is registered in the friend list.

The presence information request checking unit 286 determines whether each terminal 10 which registers the specific terminal in the friend list requests the presence information of the specific terminal.

The presence information transmitting unit 288 transmits the presence information of the specific terminal to terminal 10, which has requested or requests the presence information of the specific terminal. The presence information of the specific terminal may be transmitted through the SIP NOTIFY command.

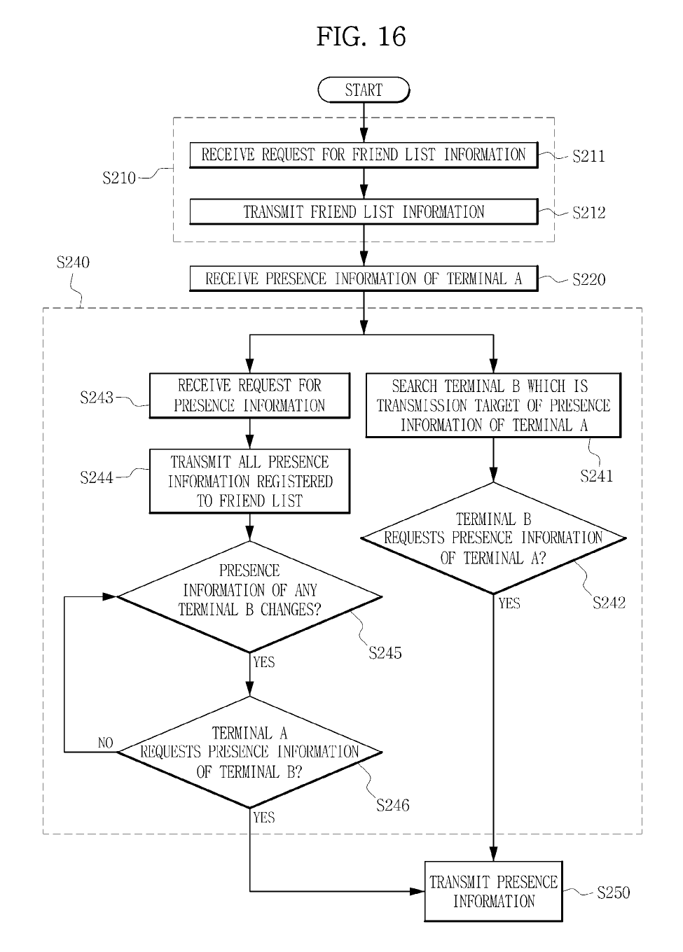

FIG. 16 is a flowchart illustrating a method for transmitting presence information according to an exemplary embodiment of the present invention. The method shown in FIG. 16 will be described as if performed by the IMS shown in FIG. 1, but is not limited as such.

Referring to FIG. 16, the IMS server 20 manages the friend list of each terminal 10 registered with the IMS server 20 (S210). Managing the friend list of each terminal 10 (S210) may include receiving a request for the friend list information (S211) and transmitting the friend list information (S212).

After which, in a case where a terminal 10 is registered to the IMS server 20 and where the presence information of the terminal 10 changes, the presence information of the terminal 10 is received (S220).

If the presence information of a specific terminal changes, a determination is made whether each terminal 10 has registered the specific terminal in their friend list, and have requested the presence information for that specific terminal (S240), and the presence information of the specific terminal is transmitted to each terminal 10 that have requested the presence information (S250).

For example, if the presence information of terminal A is received in operation S240, the IMS server 20 proceeds to the corresponding operation based on the determination (either operation S241 or S243). In other words, in operation S240, the IMS server 20 may search terminal B in which a transmission target to which the presence information of the terminal A is transmitted (S241) and make a determination of whether terminal A is included in the information request list of terminal B (S242).

Alternatively, in operation 240, if terminal A requests presence information of friends, the IMS server 20 proceeds to operation 243. In operation 243, a request for receiving the presence information from terminal A is received (S243). After which, the IMS server 20 transmits the presence information for all the friends registered in the friend list (S244). After operation S244, a determination is made as to whether the presence information for other terminals (such as a terminal b) changes. If yes, in Operation 246, a determination is made as to whether terminal A has requested presence information for these terminals that have changed. If so, the IMS server 20 transmits presence information to terminal A (S250).

Accordingly, based on the exemplary embodiment disclosed, because presence information is transmitted and received according to requests of the terminals to receive the presence information, the data traffic of a network may be reduced, and a load on a terminal may also be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a friend list unit to update a friend list of the terminal;
a presence information control unit to manage presence information, the presence information being information of another terminal associated with the friend list; and
a presence information transmitting unit to transmit a request for updated presence information of a partial portion of the friend list from a server,
wherein the friend list unit receives the updated presence information corresponding to the request and updates the presence information.

2. The terminal according to claim 1, wherein the server is an Internet Protocol Multimedia Subsystem (IMS) server.

3. The terminal according to claim 1, wherein the presence information transmitting unit requests presence information based on a Session Initiation Protocol (SIP).

4. The terminal according to claim 1, wherein the updated presence information corresponds to friends of a specific range of the friend list.

5. The terminal according to claim 4, wherein the updated specific range corresponds to friends displayed on a screen of the terminal.

6. The terminal according to claim 1, wherein the updated presence information is based on a category of friends of the friend list.

7. The terminal according to claim 1, wherein the updated presence information is based on friends of the friend list registered on a wallpaper screen.

8. The terminal according to claim 5, wherein the updated presence information further corresponds to a range of friends adjacent to friends displayed on the screen of the terminal.

9. A method for updating a friend list based on presence information, comprising:
managing the friend list based on the presence information;
designating friends of the friend list for updated presence information;
requesting the updated presence information from a server based on the designation;
receiving the updated presence information from the server; and
updating the friend list based on the received updated presence information.

10. The method according to claim 9, wherein the server is an Internet Protocol Multimedia Subsystem (IMS) server.

11. The method according to claim 9, wherein the requesting is based on a Session Initiation Protocol (SIP).

12. The method according to claim 9, wherein the updated presence information corresponds to friends of a specific range of the friend list.

13. The terminal according to claim 12, wherein the specific range corresponds to currently displayed friends.

14. The method according to claim 9, wherein the updated presence information is based on a category of friends of the friend list.

15. The method according to claim 9, wherein the updated presence information is based on friends of the friend list registered on a wallpaper screen.

16. The method according to claim 14, wherein the updated presence information further corresponds to a range of friends adjacent to currently displayed friends.

17. An Internet Protocol Multimedia Subsystem (IMS) server, comprising:
a friend list unit to manage a first terminal and a second terminal, the first terminal and the second terminal each having a friend list;
a presence information control unit to manage presence information for the first terminal and the second terminal, and to store updated presence information for the first terminal; and
a presence information transmitting unit to transmit the updated presence information for the first terminal,
wherein in response to a request from the second terminal, the presence information transmitting unit transmits the updated presence information for the first terminal to the second terminal.

18. The server according to claim 17, wherein the request is based on a Session Initiation Protocol (SIP).

19. The server according to claim 17, further comprising:
a presence information request checking unit to detect a change in presence information of the first terminal,
wherein the presence information transmitting unit transmits the updated presence information for the first terminal to the second terminal based on the detected change.

20. The server according to claim 19, wherein the friend list unit determines if the second terminal designates the first terminal, and
the presence information transmitting unit transmits the updated presence information for the first terminal to the second terminal based on the detected change and if the first terminal is designated by the second terminal.
